(19) United States
(12) Patent Application Publication
(10) Pub. No.: US 2025/0044108 A1
(43) Pub. Date: Feb. 6, 2025

(54) PATH FINDING APPARATUS, CONTROL METHOD, AND NON-TRANSITORY COMPUTER-READABLE STORAGE MEDIUM

(71) Applicant: NEC Corporation, Koto-ku, Tokyo (JP)

(72) Inventors: Florence Thi Ngoc Loan HO, Tokyo (JP); Shinji NAKADAI, Tokyo (JP)

(73) Assignee: NEC Corporation, Koto-ku, Tokyo (JP)

(21) Appl. No.: 18/713,307

(22) PCT Filed: Dec. 7, 2022
(86) PCT No.: PCT/JP2022/045002

§ 371 Date: May 24, 2024

(30) Foreign Application Priority Data
Dec. 8, 2021 (JP) 2021-198987

(51) Int. Cl. G01C 21/34

(52) U.S. Cl. CPC G01C 21/3446

(57) ABSTRACT

A path finding apparatus acquires vehicle information and map information, and determines a path set that includes a path for each of the vehicles in the vehicle set. The path set is determined using the vehicle information and the map information. The paths in the path set do not conflict with each other. To determine the path set, the path finding apparatus performs a path planning algorithm to generate the path for each of the vehicles. The path planning algorithm evaluates the path based on a utility score of the path that is a scalar value representing how much the path achieves a plurality of objectives.

### TECHNICAL FIELD

The present disclosure generally relates to a multi-agent path finding problem.

### BACKGROUND ART

The multi-agent path finding (MAPF) problem is a problem to find a path for each of multiple vehicles so that the vehicles does not conflict with each other or any static obstacles when traveling along their paths while optimizing a single objective such as the total travelled distance. NPL1 discloses an algorithm called Conflict Based Search (CBS) algorithm to solve the MAPF problem. The CBS is a two-level search algorithm, divided into high-level and low-level searches. In the high-level search, the CBS uses a binary tree named constraint tree (CT) to seek appropriate constraints of time and location of vehicles to avoid conflicts between vehicles. In the low-level search, the CBS finds a path for each vehicle under the constraints sought in the high-level search.

Since the CBS algorithm disclosed by NPL1 evaluates the paths based on a single objective, i.e., path length, it cannot handle multiple objectives. NPL2 discloses an algorithm named multi-objective conflict-based search (MO-CBS) to extend CBS to handle multiple objectives. It is noted that a generalization of the MAPF problem that handles multiple objectives is called “multiple-objective MAPF (MOMAPF)”. The MO-CBS generates multiple CTs each of which has a root node containing an initial Pareto optimal solution. In the root node, conflicts between vehicles are not considered. Then, child nodes are generated to resolve the detected conflicts. Also this approach considers a graph with predefined costs.

### CITATION LIST

### Non Patent Literature

NPL1: Guni Sharon, Roni Stern, Ariel Felner, and Nathan R. Sturtevant, “Conflict-based search for optimal multi-agent pathfinding”, Elsevier, Artificial Intelligence, Volume 219, Pages 40-66, February 2015
NPL2: Zhongqiang Ren, Sivakumar Rathinam, and Howie Choset, “Multi-objective Conflict-based Search for Multi-agent Path Finding”, [online], Jan. 11, 2021, [retrieved on 2021-12-7], retrieved from <arXiv, https://arxiv.org/pdf/2101.03805v2.pdf>
NPL3: Wei Chu and Zoubin Ghahramani, “Preference Learning with Gaussian Processes”, ACM, the 22nd International Conference on Machine Learning, Aug. 7, 2005.
NPL4: Eric Brochu, Vlad M. Cora, and Nando de Freitas, “A Tutorial on Bayesian Optimization of Expensive Cost Functions, with Application to Active User Modeling and Hierarchical Reinforcement Learning”, [online], Dec. 12, 2010, [retrieved on 2021-10-6], retrieved from <arXiv, https://arxiv.org/pdf/1012.2599.pdf>

### SUMMARY OF INVENTION

### Technical Problem

The MO-CBS is computationally expensive since it has to compute multiple Pareto-optimal solutions. An objective of this disclosure is to provide a computationally less expensive way to provide a set of paths for multiple vehicles while taking multiple objectives into account.

### Solution to Problem

The present disclosure provides a path finding apparatus that comprises at least one processor and memory storing instructions. The at least one processor is configured to execute the instructions to: acquire vehicle information and map information, the vehicle information indicating a pair of a start location and a goal location for each of a plurality of vehicles, the map information indicating a map of space in which the vehicles travel; and determine a path set that includes a path for each of the vehicles using the vehicle information and the map information, the paths in the path set not conflicting with each other.

The determination of the path set includes performing a path planning algorithm to generate the path for each of the vehicles, the path planning algorithm evaluating the path based on a utility score of the path that is a scalar value representing a degree to which a plurality of objectives are optimized by the path.

The present disclosure provides a control method performed by a computer. The control method comprises: acquiring vehicle information and map information, the vehicle information indicating a pair of a start location and a goal location for each of a plurality of vehicles, the map information indicating a map of space in which the vehicles travel; and determining a path set that includes a path for each of the vehicles using the vehicle information and the map information, the paths in the path set not conflicting with each other.

The determination of the path set includes performing a path planning algorithm to generate the path for each of the vehicles, the path planning algorithm evaluating the path based on a utility score of the path that is a scalar value representing a degree to which a plurality of objectives are optimized by the path.

The present disclosure provides a non-transitory computer readable storage medium storing a program that causes a computer to execute the control method of the present disclosure described above.

### Advantageous Effects of Invention

According to the present disclosure, a computationally less expensive way to provide a set of paths for multiple vehicles while taking multiple objectives into account is provided.

### BRIEF DESCRIPTION OF DRAWINGS

FIG. 1 illustrates an overview of the path finding apparatus of the first example embodiment.

FIG. 2 is a block diagram illustrating an example of a functional configuration of the path finding apparatus.

FIG. 3 is a block diagram illustrating an example of the hardware configuration of a computer realizing the path finding apparatus.

FIG. 4 is a flowchart illustrating an example of a process performed by the path finding apparatus of the first example embodiment.

FIG. 5 illustrates an example structure of the vehicle information in a table format.

FIG. 6 is a flowchart illustrating an overall flow of the CBS.

FIG. 7 is a flowchart illustrating an example flow of the GA path planner performed by the MAPF solving unit.

FIG. 8 illustrates an example of crossover step.

FIG. 9 illustrates a delete of the waypoint from the candidate path for mutation.

FIG. 10 illustrates an addition of one or more waypoints to the candidate path for mutation.

FIG. 11 illustrates an addition of one or more waypoints to the candidate path for mutation.

FIG. 12 illustrates an overview of the path finding apparatus of the second example embodiment.

FIG. 13 is a block diagram that illustrates an example of functional configurations of the path finding apparatus of the second example embodiment.

FIG. 14 is a flowchart illustrating an example of a process performed by the path finding apparatus of the second example embodiment.

FIG. 15 illustrates a visual provision of the multiple candidates of the path set.

### DESCRIPTION OF EMBODIMENTS

Example embodiments according to the present disclosure will be described hereinafter with reference to the drawings. The same numeral signs are assigned to the same elements throughout the drawings, and redundant explanations are omitted as necessary. In addition, a storage unit is formed with one or more storage devices.

### First Example Embodiment

### Overview

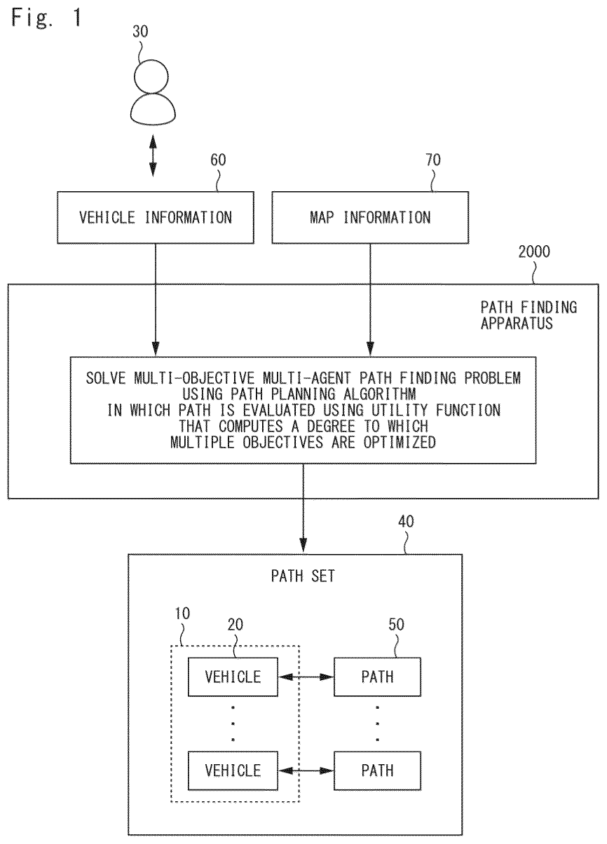

FIG. 1 illustrates an overview of the path finding apparatus 2000 of the first example embodiment. Note that the overview illustrated by FIG. 1 shows an example of operations of the path finding apparatus 2000 to make it easy to understand the path finding apparatus 2000, and does not limit or narrow the scope of possible operations of the path finding apparatus 2000.

The path finding apparatus 2000 operates to generate a path set 40 for a vehicle set 10. The path set 40 is a set of paths 50, and includes the path 50 for each of multiple vehicles 20 included in the vehicle set 10. Each vehicle 20 is configured to travel from its start location to its goal location along the corresponding path 50.

Suppose that the vehicle set 10 includes N vehicles {v1, . . . , vN}. The path finding apparatus 2000 is required to generate a path set {p1, . . . , pN} for the vehicle set 10 wherein the path pi corresponds to the vehicle vi for each i from 1 to N.

The vehicle set 10 is a set of vehicles 20, and may be in association with an entity 30. The entity 30 may be arbitrary entity that is responsible for the vehicle set 10. For example, the entity 30 may be an operator of the vehicles 20 in the vehicle set 10 or a company that owns or manages the vehicle set 10.

The vehicle 20 may be arbitrary moving object that is controllable to travel along the corresponding path 50. In some implementations, the vehicle 20 may be arbitrary type of autonomous vehicle such as an automatic guided vehicle (AGV), a drone, and so on. In other implementations, the vehicle 20 may be arbitrary type of moving object that is manually operated.

The start and goal locations are pre-defined for each vehicle 20. In order to know the start and goal locations of the vehicles 20, the path finding apparatus 2000 may acquire vehicle information 60 that indicates the start and goal locations for each vehicle 20 in the vehicle set 10.

There are at least two requirements regarding the generation of the path set 40. First, the path set 40 is required to be conflict-free, i.e., each path 50 conflicts with neither one of the other paths in the path set 40. Second, the path set 40 is required to be generated so that multiple pre-defined objectives are substantially optimized. There are various objectives that can be considered. Some examples of the objectives are efficiency, safety, and smoothness of the paths 50 in the path set 40. These objectives will be explained in detail later.

In order to find the path set 40 that satisfies the at least two requirements mentioned above, the path finding apparatus 2000 generates the path set 40 by solving a multi-objective multi-agent path finding (MOMAPF) problem. Hereinafter, an algorithm that is performed by the path finding apparatus 2000 to solve the MOMAPF problem is called “MOMAPF solver”. The MOMAPF solver repeatedly generates the path set 40 until it finds the path set 40 that satisfies the above-mentioned two requirements: being conflict free and substantially optimizing the multiple objectives.

In order to define a MOMAPF problem to be solved, (1) a map of space in which vehicles 20 can travel around and (2) start and goal locations for each vehicle 20 are at least required. Regarding (1), the path finding apparatus 2000 acquires map information 70 that indicates the map of space in which vehicles 20 can travel around. Regarding (2), as mentioned above, the start and goal locations for each vehicle 20 is shown in the vehicle information 60.

In order to meet the second requirement, the path finding apparatus 2000 considers utility for each path 50. The utility of the path 50 is defined so as to become higher as the path 50 becomes better from the viewpoint of the multiple objectives. The path finding apparatus 2000 measures the utility of the path 50 using a utility function that is defined to compute a utility score of the path 50 that represents a degree to which multiple objectives are optimized by the path 50. As described in detail later, the utility function may be defined as a weighted sum of multiple objective terms each of which represent a degree to which the corresponding objective is optimized.

In order to enable the MOMAPF solver to evaluate the utility of each path 50, the MOMAPF solver generates each path 50 using a path planning algorithm such as metaheuristic algorithm (e.g., an evolutionary algorithm (EA)), heuristic search algorithm, exhaustive search algorithm, etc. Hereinafter, as examples, it is assumed that the path planning algorithm is implemented as a metaheuristic algorithm, and the metaheuristic algorithm used in the MOMAPF solver to generate each path 50 is called an “EA path planner”. The EA path planner uses the utility function to compute the utility score for each candidate of the path 50 generated by it.

### Example of Advantageous Effect

According to the path finding apparatus 2000 of the first example embodiment, the path set 40 that includes conflict-free paths for multiple vehicles 20 in the vehicle set 10 is generated. Since the path finding apparatus 2000 uses the utility function that scalarizes a degree to which multiple objectives are optimized, it can find the best set of paths from the viewpoint of multiple objectives. Thus, unlike MO-CBS disclosed by NPL2 that provides entire Pareto set of solutions, the path finding apparatus 2000 can provides a single set of conflict-free paths with highest utility instead of providing multiple Pareto-optimal conflict-free paths.

The path finding apparatus 2000 is advantageous over MO-CBS in practicality and efficiency. Specifically, the path finding apparatus 2000 can provide a practical solution to an operator or the like with much less runtime than MO-CBS since it can provide a solution that is one of an entire Pareto-optimal set of solutions or close thereto without computing the entire Pareto-optimal set of solutions. In other words, the path finding apparatus 2000 can provide a solution in a computationally less expensive way than that disclosed by NPL2. In addition, the path finding apparatus 2000 does not require an operator to select an optimal solution from the entire Pareto-optimal set of solutions, thereby reducing the time and effort that the operator takes to obtain a solution. Furthermore, it may be sufficient for an operator to know a single optimal solution, and knowing the whole Pareto-optimal set of solutions may not be practical for the operator.

Hereinafter, more detailed explanation of the path finding apparatus 2000 will be described.

### Example of Functional Configuration

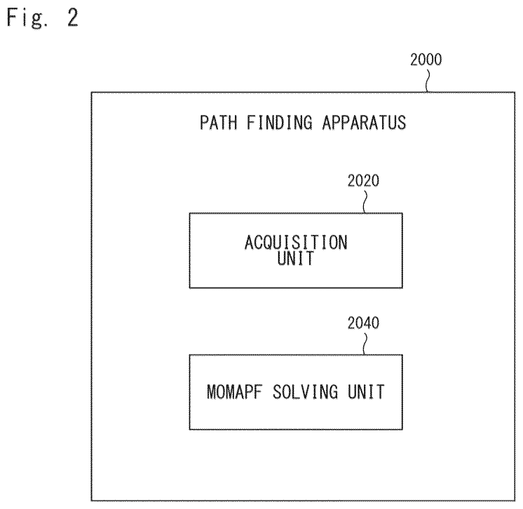

FIG. 2 illustrates an example of a functional configuration of the path finding apparatus 2000. The path finding apparatus 2000 includes an acquisition unit 2020 and a MOMAPF solving unit 2040. The acquisition unit 2020 acquires the vehicle information 60 and the map information 70. The MOMAPF solving unit 2040 solves the MOMAPF problem in which the map is defined by the map information 70 and the start and goal locations of each vehicle 20 are defined by the vehicle information 60, to generate the path set 40 for the vehicle set 10. The MOMAPF problem is solved by executing the MOMAPF solver. In the MOMAPF solver, for each vehicle 20, the EA path planner is invoked to generate the path 50 of the vehicle 20. In the EA path planner, the path 50 is evaluated from the viewpoint of multiple objectives using the utility function.

### Example of Hardware Configuration

The path finding apparatus 2000 may be realized by one or more computers. Each of the one or more computers may be a special-purpose computer manufactured for implementing the path finding apparatus 2000, or may be a general-purpose computer like a personal computer (PC), a server machine, or a mobile device.

The path finding apparatus 2000 may be realized by installing an application in the computer. The application is implemented with a program that causes the computer to function as the path finding apparatus 2000. In other words, the program is an implementation of the functional units of the path finding apparatus 2000.

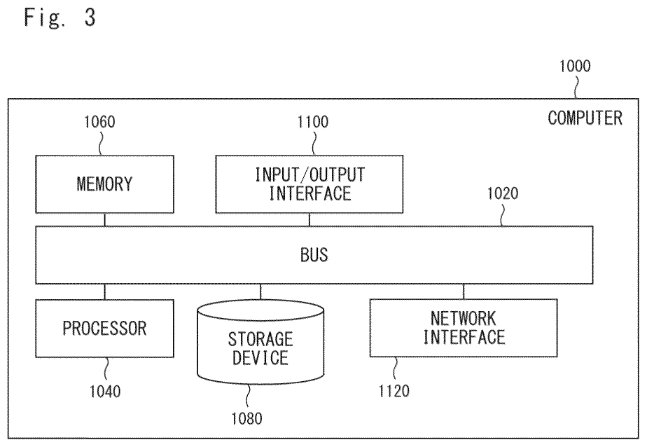

FIG. 3 is a block diagram illustrating an example of the hardware configuration of a computer 1000 realizing the path finding apparatus 2000. In FIG. 3, the computer 1000 includes a bus 1020, a processor 1040, a memory 1060, a storage device 1080, an input/output interface 1100, and a network interface 1120.

The bus 1020 is a data transmission channel in order for the processor 1040, the memory 1060, the storage device 1080, and the input/output interface 1100, and the network interface 1120 to mutually transmit and receive data. The processor 1040 is a processer, such as a CPU (Central Processing Unit), GPU (Graphics Processing Unit), or FPGA (Field-Programmable Gate Array). The memory 1060 is a primary memory component, such as a RAM (Random Access Memory) or a ROM (Read Only Memory). The storage device 1080 is a secondary memory component, such as a hard disk, an SSD (Solid State Drive), or a memory card. The input/output interface 1100 is an interface between the computer 1000 and peripheral devices, such as a keyboard, mouse, or display device. The network interface 1120 is an interface between the computer 1000 and a network. The network may be a LAN (Local Area Network) or a WAN (Wide Area Network).

The storage device 1080 may store the program mentioned above. The CPU 1040 executes the program to realize each functional unit of the path finding apparatus 2000.

The hardware configuration of the computer 1000 is not limited to the configuration shown in FIG. 3. For example, as mentioned-above, the path finding apparatus 2000 may be realized by plural computers. In this case, those computers may be connected with each other through the network.

### <Flow of Process>

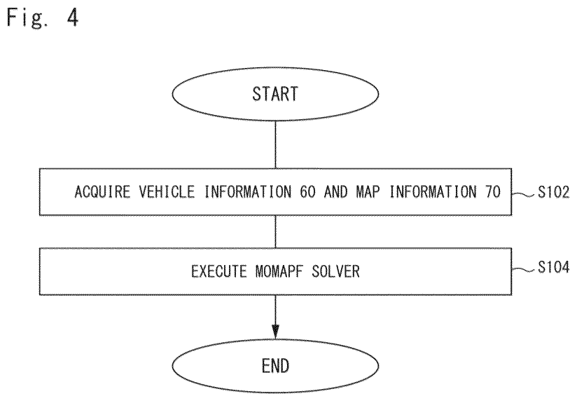

FIG. 4 is a flowchart illustrating an example of a process performed by the path finding apparatus 2000. The acquisition unit 2020 acquires the vehicle information 60 and the map information 70 (S102). The MOMAPF solving unit 2040 executes the MOMAPF solver to solve the MOMAPF problem that is defined by the map indicated by the map information 70 and the start and goal locations of vehicles 20 indicated by the vehicle information 60 (S104).

### <Acquisition of Vehicle Information 60: S102>

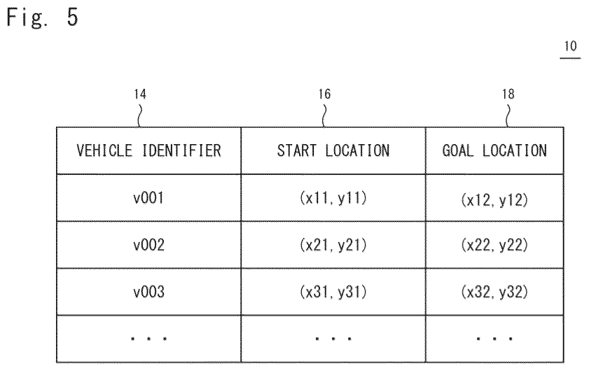

The acquisition unit 2020 acquires the vehicle information 60 (S102). The vehicle information 60 indicates the start and goal locations for each vehicle. FIG. 5 illustrates an example structure of the vehicle information 60 in a table format. The vehicle information 60 in FIG. 5 includes tuples of a vehicle identifier 22, a start location 24, and a goal location 26. Each tuple indicates a pair of the start and goal locations for the corresponding vehicle.

There may be various ways to acquire the vehicle information 60. For example, the vehicle information 60 is stored in advance in association with the identifier of the corresponding entity in a storage unit to which the path finding apparatus 2000 has access. In this case, the acquisition unit 2020 acquires, from the storage unit, the vehicle information 60 that is associated with the identifier of the entity 30. Note that the acquisition unit 2020 acquires the identifier of the entity 30 in arbitrary manner, such as receiving a user input that specifies the identifier of the entity 30.

In another example, the acquisition unit 2020 may acquire the vehicle information 60 by receiving it that is sent from another computer, such as a mobile device or a PC operated by the entity 30.

### <Acquisition of Map Information 70: S102>

The acquisition unit 2020 acquires the map information 70 (S102). The map information 70 represents a map of the space in which the vehicles 20 travel around. Theoretically, the map may represent a graph G=(V,E) wherein V is a set of vertexes and E is a set of edges. The vertexes represent locations, and the edges represent connections between locations.

There are various ways to implement a map of space for a MOMAPF problem. In some implementations, the map is implemented as a two-dimensional (2D) or three-dimensional (3D) grid map. In this case, each location is represented by a cell in the grid map. In addition, each connection between locations is represented by a connection between cells in the grid map.

The map information 70 may also indicates a location of each stationary obstacle, such as a wall, shelf, and so on. Each obstacle is defined by one or more locations (e.g., cells of the grid map) that are permanently occupied at least during the travel of the vehicles 20.

There may be various ways to acquire the map information 70. For example, the map information 70 is stored in advance in a storage unit to which the path finding apparatus 2000 has access. In this case, the acquisition unit 2020 acquires the map information 70 from the storage unit. In another example, the acquisition unit 2020 may acquire the map information 70 by receiving it that is sent from another computer.

### <Solving MOMAPF Problem: S104>

The MOMAPF solving unit 2040 executes the MOMAPF solver to solves the MOMAPF problem that is defined based on the map information 70 and the vehicle information 60, to generate the path set 40 for the vehicle set 10. In some implementations, the MOMAPF solver is implemented by a modified version of a Conflict Based Search (CBS) algorithm. It is noted that an original version of the CBS is disclosed by NPL1. Hereinafter, the modified version of the CBS employed in the path finding apparatus 2000 is called a “modified CBS”.

The CBS is a two-level search algorithm, divided into high-level and low-level searches. The high-level search is performed using a binary search tree called constraint tree (CT). Each node of the CT contains (1) time and location constraints related to the conflicts that are detected by the low-level search performed at its parent node; (2) a single candidate solution (i.e., a candidate set of paths of all vehicles) that satisfies all constraints indicated by that node and its ancestors; and (3) the evaluation of the solution, which is the sum of total paths duration of all vehicles in the original CBS. The root node of the CT contains an empty set of constraints.

The constraint contained in the node indicates which vehicle 20 is prohibited from occupying which location at which time. For example, it is detected that a vehicle A1 and A2 conflicts with each other at the location L1 at time T1. In this case, the constraint that “the vehicle A1 must not occupy the location L1 at time T1” or the constraint that “the vehicle A2 must not occupy the location L1 at time T1” can be employed to avoid the conflict.

For each node of the CT, the low-level search is invoked for a vehicle 20 whose path 50 has to be replanned. In the low-level search, the original CBS uses an A* search algorithm as a path planning algorithm to find a new path for the vehicle while satisfying the constraints indicated by the current node and its ancestors. On the other hand, the modified CBS uses the EA path planner (i.e., a metaheuristic algorithm) as the path planning algorithm in the low-level search.

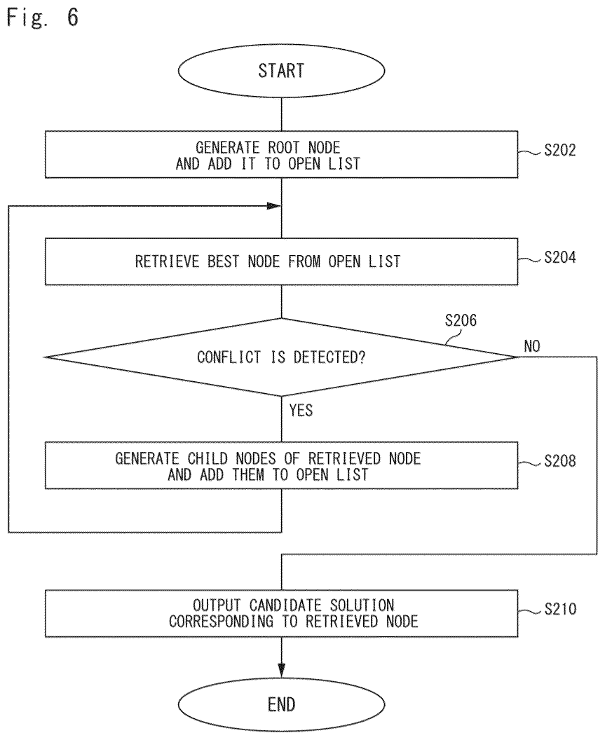

An overall flow of the CBS is explained below with referring to FIG. 6. FIG. 6 is a flowchart illustrating an overall flow of the CBS. In is noted that the overall flow shown by FIG. 6 is common between the original and modified CBS. First, the CT is initialized by generating a root node and adding the root node to an open list (S202). The step of generating a node of CT includes: (1) generating a candidate solution for the node under the constraints indicated by the node and its ancestors; and (2) evaluating the solution. The solution and its evaluation are set to the node. The open list includes one or more nodes whose candidate solution is to be checked whether or not it is conflict-free.

It is noted that, when generating the root node, the candidate solution is generated by invoking the path planning algorithm for each vehicle individually to generate the path for each vehicle. On the other hand, when generating a node other than the root node, the candidate solution is generated by applying the path planning algorithm for a single vehicle whose path is required to be replanned due to the conflict with another path, and replacing the old path of the vehicle with the new one. Except for this new path, the candidate solution of this node is the same as that of the parent node.

Steps S204 to S208 are repeated until a conflict-free solution is found. At Step 204, the best node is retrieved from the open list. The best node is a node with highest evaluation. In the case of the original CBS, the node with lowest cost is retrieved as the best node. On the other hand, as described in detail later, the modified CBS retrieves the node with highest utility as the best node.

The retrieved node is checked whether or not its corresponding candidate solution is conflict-free (S206). In the case where the candidate solution corresponding to the retrieved node is conflict-free (S206: YES), the CBS terminates after outputting this candidate solution as the solution of the MOMAPF problem to be solved (S210).

On the other hand, in the case where the candidate solution corresponding to the retrieved node is not conflict-free (S206: NO), child nodes of the retrieved node are generated and added to the open list (S208).

The modified CBS is different from the original one in at least following two points. First, the modified CBS uses the EA path planner as the path planning algorithm in the low-level search instead of the A* search algorithm. Second, the modified CBS evaluates the candidate solution from the viewpoint of multiple objectives. Due to the nature of the A* algorithm, the original CBS cannot handle multiple objectives, but only a single objective (path length). On the other hand, since evolutionary algorithms do not have this limitation, the EA path planner can handle multiple objectives.

Hereinafter, these two points will be explained in more detail.

### <<Evolutionary Algorithm for Low-Level Search>>

As mentioned above, in the modified CBS, the path planning algorithm for the low-level search is implemented by the EA path planner. In some implementations, the EA path planner is implemented by a genetic algorithm, which belongs to evolutionary algorithms. Hereinafter, the EA path planner implemented by a genetic algorithm and employed for the low-level search in the modified CBS is called a “GA path planner”.

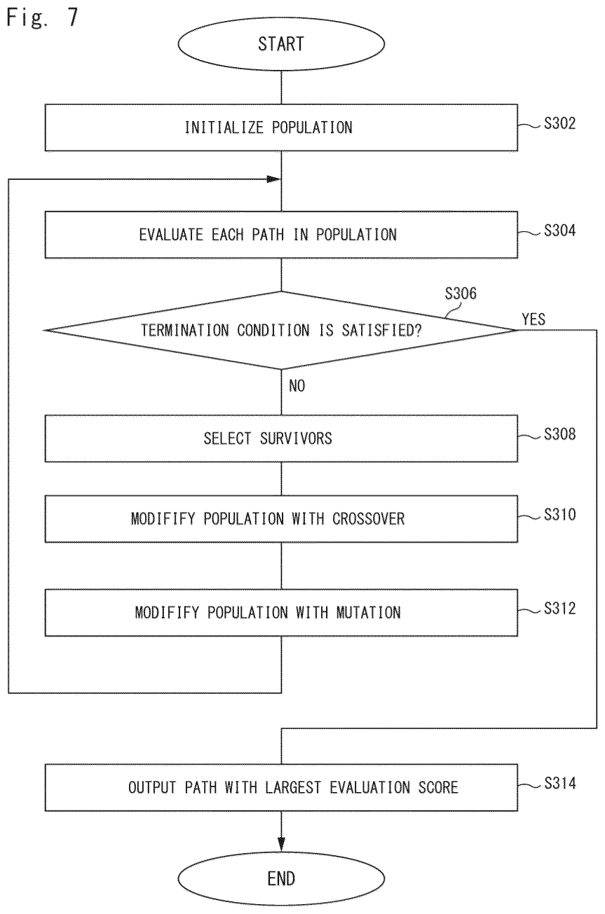

FIG. 7 is a flowchart illustrating an example flow of the GA path planner performed by the MOMAPF solving unit 2040. It is noted that, as mentioned above, the low-level search is performed for a vehicle 20 at a node of the CT under the constraints indicated by that node and its ancestors. Hereinafter, the vehicle 20 for which the GA path planner is invoked is called “target vehicle”.

First, the GA path planner generates initial population of candidate paths for the target vehicle under the constraints corresponding to the current node of the CT and its ancestors (S302). In general GA algorithms, the term “population” means a set of candidate solutions. In the case of the GA path planner, the population represents a set of candidate paths (i.e., candidates of the path 50) for the target vehicle. The population is initialized by randomly generating multiple candidate paths that are paths from the start location to the goal location of the target vehicle.

Steps S304 to S312 are repeatedly performed until it is determined that a pre-defined termination condition is satisfied at Step S306. The termination condition will be explained later.

At S304, the GA path planner evaluates each candidate path in the population using the utility function. Then, the GA path planner checks whether or not the termination condition is satisfied (S306). In the case where the termination condition is satisfied (S306: YES), the GA path planner outputs the candidate path with highest utility in the current population (S314), and then terminates.

In the case where the termination condition is not satisfied (S306: NO), the GA path planner applies genetic operators (selection, crossover, and mutation) to the population in order to convert it to the next generation. At Step S308, the GA path planner selects survivors from the population. The survivors are the candidate paths kept in the population. In other words, the rest of the population (i.e., the candidate paths other than the survivors) are deleted from the population. There are various well-known ways to choose survivors in GA algorithms, such as a random selection, and any one of them can be employed.

Next, the GA path planner generates new candidate paths by modifying one or more candidate paths in the population with crossover and add the generated candidate paths to the population (S310). Then, the GA path planner generates new candidate paths by modifying one or more candidate paths in the population with mutation and adds the generated candidate paths to the population (S312). More details of these modifications will be explained later. It is noted that the modification with mutation may be performed before that with crossover.

After applying the genetic operators to the population, the GA path planner goes back to Step S304: the evaluation of the population. By doing so, the conversion of the population into the next generation and the evaluation of the population are repeatedly performed until the termination condition is satisfied.

There are various termination conditions that can be employed for the GA path planner. For example, the termination condition may include a condition “the number of iterations reaches a pre-defined threshold”. In this case, the GA path planner terminates when Step S306 is performed more than pre-determined times.

Alternatively, or in addition, the termination condition may include a condition “change in a fitness level is less than a predefined threshold for a given number of iterations”. This means that the GA path planner is executed until convergence. In GA algorithms, the fitness level represents how the current solution is close to the optimum solution of a given problem. In the GA path planner, in each iteration, the highest utility score of ones computed for the candidate paths in the population can be used as the value of the fitness level.

Hereinafter, the modifications with crossover and mutation are explained in more detail.

<<<Modification with Crossover>>>

The crossover step is primarily responsible for improving the generations to obtain better candidate paths. The improvement is achieved by recombining two or more individuals (candidate paths in the population) called parents to generate better solutions called offsprings.

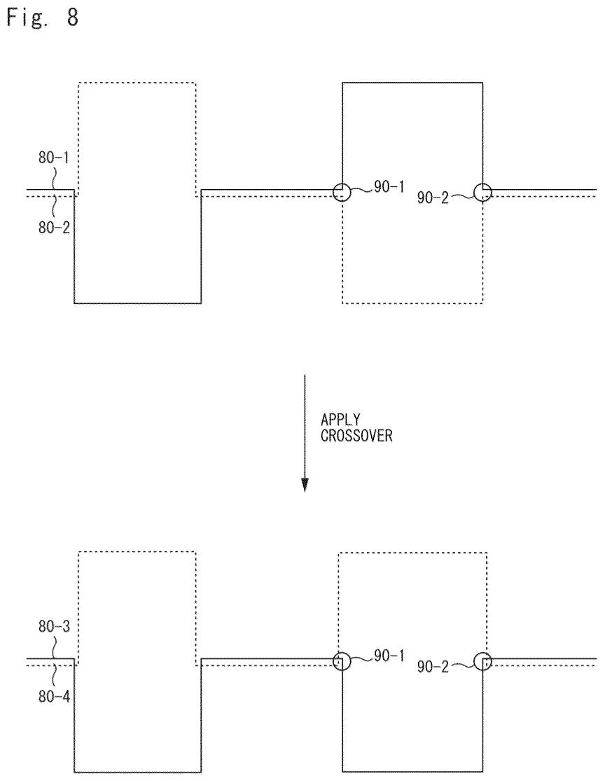

In the context of the GA path planner, the crossover step includes combines two parent candidate paths, i.e., survivors after the selection step, into new offspring paths. FIG. 8 illustrates an example of crossover step. The candidate paths 80-1 and 80-2 have two common locations 90-1 and 90-2. The modification with crossover is applied to the candidate paths 80-1 and 80-2, thereby generating candidate paths 80-3 and 80-4. Specifically, the candidate paths 80-3 and 80-4 are generated by exchanging the portion of the candidate path 80-1 between the locations 90-1 and 90-2 with the portion of the candidate path 80-2 between the locations 90-1 and 90-2.

The candidate paths to which the crossover step is applied are required to have at least one common location therein. Thus, the GA path planner may search the population for one or more pairs of the two candidate paths having at least one common locations, and applies the crossover step to the one or more pairs found.

<<<Modification with Mutation>>>

The mutation step consists in giving a required diversity to explore the solution space and prevent the population from being stuck in a local optimum. In the GA path planner, one or more types of mutation moves are used to explore possibly better solutions. For example, the GA path planner modifies parts of a candidate path by performing random moves or informed moves. In the case of the random moves, the GA path planner randomly selects one or more parts of the candidate path, and modify the selected parts in a random manner.

More specifically, the GA path planner randomly selects a waypoint that is located before the earliest conflict. It is noted that the waypoint is a set of location and time with which a single point in the path is described. Then, the set of possible modifications in a neighborhood of the randomly selected waypoint is determined, and a move is randomly selected among them. There may be two types of possible modifications: detour and wait move. The detour is a modification to spatially modify a portion of the path. The wait move is a modification to add a new waypoint whose location is the same as that of the randomly selected waypoint and whose time is different from that of the randomly selected waypoint, thereby adding one more time steps to the path. It is noted that the GA path planner may randomly select two or more waypoints, and perform a move for each one of the randomly selected waypoints.

If the path after the modification is infeasible, the selection is repeated until a feasible solution is found. If the set of the possible modifications contains no feasible move, it is incremented in the sense that the detour neighborhood around the selected waypoint and the wait time step are increased.

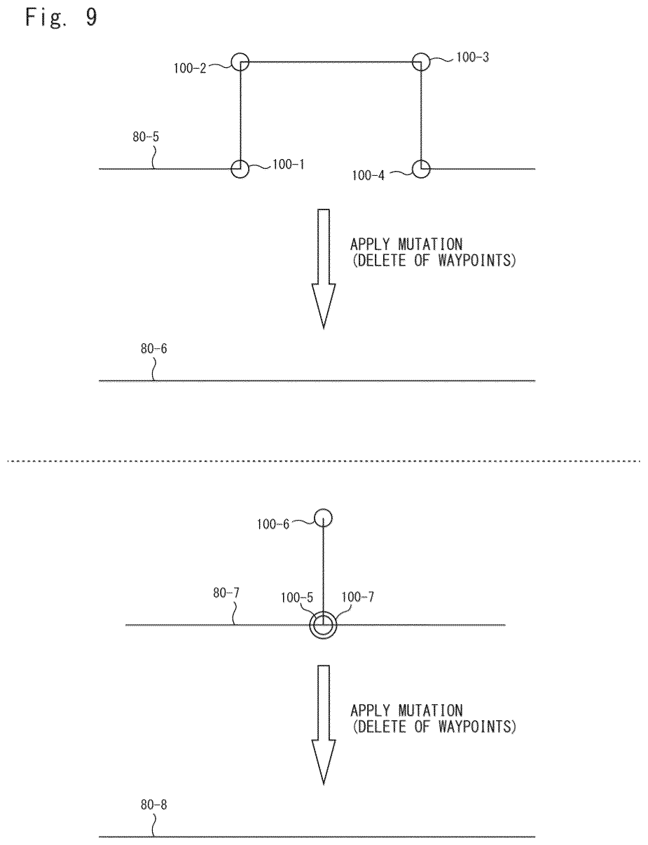

Regarding the informed moves, the GA path planner detects one or more parts of the candidate path that satisfy a predefined condition, and modifies the detected parts in a predefined way. In some implementations, the informed moves may include a delete of one or more waypoints. When performing the delete of the waypoint, the GA path planner detects waypoints forming a detour, and delete those waypoints to remove the detour from the candidate path. FIG. 9 illustrates a delete of the waypoint from the candidate path for mutation. For the sake of simplicity, FIG. 9 shows only the waypoints at which the vehicle changes direction. In the top picture in FIG. 9, a candidate path 80-5 includes waypoints 100-1, 100-2, 100-3, and 100-4 that form a detour. In this example, a new candidate path 80-6 is generated by deleting the waypoints 100-1 to 100-4. By deleting waypoints at which the vehicle changes directions, the number of turns in the candidate path is reduced, and thus the smoothness of the candidate path is increased.

In the bottom picture in FIG. 9, a candidate path 80-7 includes waypoints 100-5, 100-6, and 100-7 that form a detour. In this example, a new candidate path 80-8 is generated by deleting the waypoints 100-1 to 100-3.

In other implementations, the informed moves may include an addition of waypoints. The addition of waypoints may be performed to resolve a conflict with a path of a vehicle other than the target vehicle. Specifically, the GA path planner detects one or more parts of the candidate path at which it conflicts with a path of a vehicle other than the target vehicle. Then, the GA path planner adds waypoints to the candidate path to avoid the conflict.

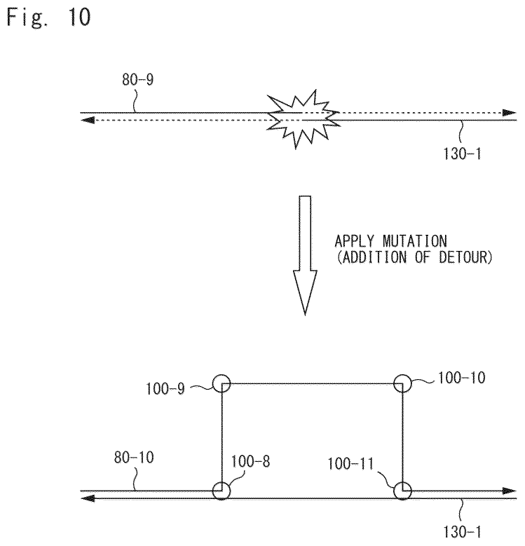

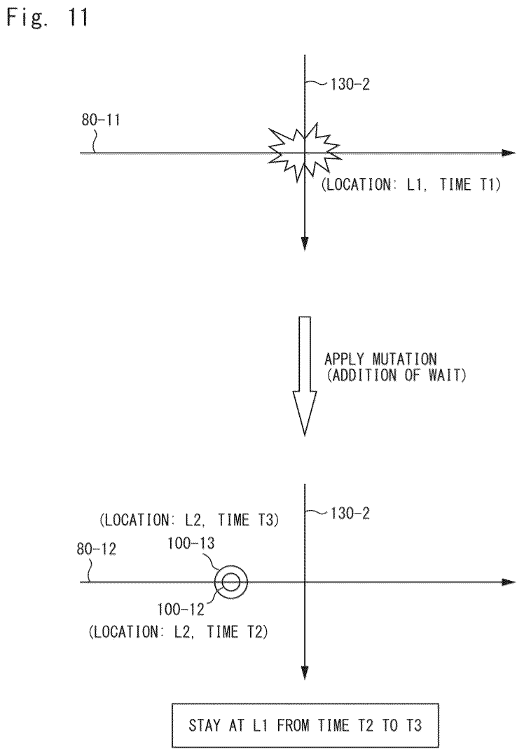

There may be at least two ways to add waypoints to the path: adding waypoints in space; and adding waypoints in time. FIGS. 10 and 11 illustrate an addition of one or more waypoints to the candidate path for mutation. In FIG. 10, a candidate path 80-9 has an edge conflict with a path 130-1 whose direction is opposite to that of the candidate path 80-9. The edge conflict is a type of conflict in which two vehicles move through the same edge from opposite directions.

The GA path planner may randomly add waypoints around the location of the edge conflict, thereby adding a detour to the candidate path 80-9 to resolve the edge conflict with the path 130-1. Specifically, four waypoints 100-8, 100-9, 100-10, and 100-11 are added to the candidate path 80-9, thereby generating a candidate path 80-10.

In FIG. 11, a candidate path 80-11 has a vertex conflict with a path 130-2 at location L1 at time T1. The vertex conflict is a type of conflict in which two vehicles occupy the same location at the same time. The vertex conflict can be resolved if one of the vehicles waits until the other vehicle passes through the location at which the conflict occurs.

Thus, in the case of FIG. 11, the GA path planner may randomly add waypoints on some random location that is located before the location of the vertex conflict and which is not in conflict with another existing vehicle. In FIG. 11, the GA path planner may add two waypoints 100-12 and 100-13 to the candidate path 80-11, thereby generating a candidate path 80-12. The waypoint 100-12 indicates (location: L2, time: T2) whereas the waypoint 100-13 indicates (location: L2, time: T3), wherein T2<T1<T3. By adding two waypoints that indicate the same location but different time, a wait action is added to the candidate path. In the case of FIG. 11, the target vehicle is scheduled to stay at the location L2 from time T2 to T3. Thus, the vehicle moving along the path 130-2 passes through the location L1 while the target vehicle stays the location L2. As a result, the vertex conflict is resolved.

### <<Evaluation of Candidate Path>>

During the execution of the GA path planner, each candidate path in the population is evaluated from the viewpoint of multiple objectives. Specifically, the candidate path is evaluated using the utility function that computes the utility score for the candidate path. The utility score is a scalar value that represents a degree to which multiple objectives are optimized. Thus, the utility of the candidate path is scalarized as the utility score by the utility function from the viewpoint of multiple objectives.

There are various objectives that can be considered. Some examples of the objectives are (1) efficiency, (2) safety, and (3) smoothness. The efficiency of a candidate path may be defined as the total length of the candidate path. Specifically, the shorter the total length of the candidate path is, the more efficient the candidate path is evaluated to be. In this case, the efficiency of a candidate path may be computed as follows:

$$\begin{matrix}Equation 1 & \\ ef ( P ) = {\sum }_{{x}_{i} ∈ P} d ( {x}_{i} , {x}_{i + 1} ) & ( 1 )\end{matrix}$$

wherein ef(P) represents the efficiency of a path P; x_i represents an i-th location in the path P; d(A,B) represents the distance between the locations A and B.

The safety of a candidate path may be defined as the shortest distance between the target vehicle path and obstacles. Specifically, the longer the shortest distance between the target vehicle and obstacles is, the safer the path is evaluated to be. In this case, the safety of a candidate path may be computed as follows:

$$\begin{matrix}Equation 2 & \\ sa ( P ) = 1 / {min}_{i} {min}_{j} d ( \overline{{x}_{i} {x}_{i + 1}} , {O}_{j} ) & ( 2 )\end{matrix}$$

wherein sa(P) represents the safety of a path P; d(A,B) represents the distance between A and B; an overline represents a line segment between two locations; and Oj represents a j-th obstacle.

In another example, the safety of a candidate path may be computed as follows:

$$\begin{matrix}Equation 3 & \\ sa ( P ) = - {min}_{i} {min}_{j} d ( \overline{{x}_{l} {x}_{l + 1}} , {O}_{j} ) & ( 3 )\end{matrix}$$

The smoothness of a candidate path may be defined as an average change of angles during the travel along the candidate path. Specifically, the smaller the average change of angles in a candidate path is, the smoother the candidate path is evaluated to be. The smoothness of a candidate path may be computed as follows:

$$\begin{matrix}Equation 4 & \\ sm ( P ) = \frac{{\sum }_{i} angle ( {x}_{i} , {x}_{i + 1} , {x}_{i + 2} )}{N} & ( 4 )\end{matrix}$$

wherein sm(P) represents the smoothness of the candidate path P; x_i is an i-th location in the candidate path P; angle(A,B,C) is an angle between lines BA and BC; and N represents the number of angles summed up in the equation (4), i.e., the number of waypoints in the candidate path P minus 2.

In another example, the smoothness of a candidate path may be defined as the number of turns. In this case, the smoothness of a candidate path may be computed as follows:

$$\begin{matrix}Equation 5 & \\ sm ( P ) = \vert T \vert & ( 5 )\end{matrix}$$

$$with T = \{ t \vert t = angle ( {x}_{i} , {x}_{i + 1} , {x}_{i + 2} ) \neq 180 \}$$

As mentioned above, the utility of the candidate path is computed using the utility function that outputs a scalar value named utility score. For example, the utility function is defined as a weighted sum of multiple objective terms each of which represents a degree to which the corresponding objective is optimized. In this case, the utility function may be defined as follows:

$$\begin{matrix}Equation 6 & \\ u ( P ) = {\sum }_{1 \leq i \leq N} {w}_{i} * \frac{{f}_{i} ( P )}{{n}_{i}} & ( 6 )\end{matrix}$$

$$with {\sum }_{1 \leq i \leq N} {w}_{i} = 1$$

wherein u(P) represents the utility score of the candidate path P, i represents an identifier of the objective, w_i represents a weight assigned to the i-th objective; f_i( ) represents a function that outputs a scalar value that represents the utility of the candidate path P from the viewpoint of the i-th objective; n_i represents a normalization factor, and N represents the number of objectives.

In the case where the efficiency, safety, and smoothness are used as objectives, the utility function may be defined as follows:

$$\begin{matrix}Equation 7 & \\ u ( P ) = {w}_{1} * \frac{ef ( P )}{{n}_{ef}} + {w}_{2} * \frac{sa ( P )}{{n}_{sa}} + {w}_{3} * \frac{sm ( P )}{{n}_{sm}} & ( 7 )\end{matrix}$$

$$with {w}_{1} + {w}_{2} + {w}_{3} = 1$$

wherein n_ef, n_sa, and n_sm represents normalization factors of the efficiency, safety, and smoothness respectively.

The weight assigned to each objective may be manually defined in advance. However, as described later in detail, the weights of the objectives may be dynamically determined by the path finding apparatus 2000 based on a preference of a user.

It is noted that, in the explanations above, the efficiency, safety, and smoothness explained above are better as their values are smaller. Thus, the utility of the candidate path P is evaluated to be higher as the utility score u(P) is smaller. The GA path planner therefore selects the candidate path with smallest utility score as that with highest utility.

It is also noted that the objectives to be considered are not limited to the efficiency, safety, and smoothness of the path. For example, energy consumption of the vehicles or task allocation for the vehicles may be handled as objectives.

It is also noted that the utility of the path is not limited to the weighted sum of multiple objectives. Arbitrary way that can compute a single scalar value taking a degree of optimization of multiple objectives into account can be employed. For example, Tchebycheff method can be employed.

In order to determine the best node at Step 204 of FIG. 6, the MOMAPF solver evaluates utility of a candidate of the path set 40 for each node. The utility of a candidate of the path set 40 may be computed based on the utility score of each path in the candidate. For example, the MOMAPF solver computes a utility score of a path set as the sum of the utility scores of all paths in the path set. In another example, the MOMAPF solver computes a utility score of a path as a statistical value (e.g., average value, minimum value, maximum value, and so on) of the utility scores of all paths in the path set.

In the case where the utility of a path is higher as its utility score is smaller, the utility of a path set is higher as its utility score is smaller. Thus, the node that is selected as the best node by the MOMAPF solver contains the candidate of the path set whose utility score is smallest of all.

### <Output of Result>

The MOMAPF solving unit 2040 acquires the path set 40 as a solution of the MOMAPF problem that is solved by the MOMAPF solver. The path finding apparatus 2000 may output the information (hereinafter, output information) indicating the path set 40. There are various ways to output the output information. In some implementations, the path finding apparatus 2000 may put the output information in a storage device. In other implementations, the path finding apparatus 2000 may output the output information to a display device so that the display device displays the output information. In this case, the display device may display the map indicated by the map information 70, the start and goal locations of each vehicle 20 indicated by the vehicle information 60, and the path 0 5 of each vehicle 20 included in the path set 40. In other implementations, the path finding apparatus 2000 may send the output information to arbitrary computer that uses the path set in some ways.

### Second Example Embodiment

### Overview

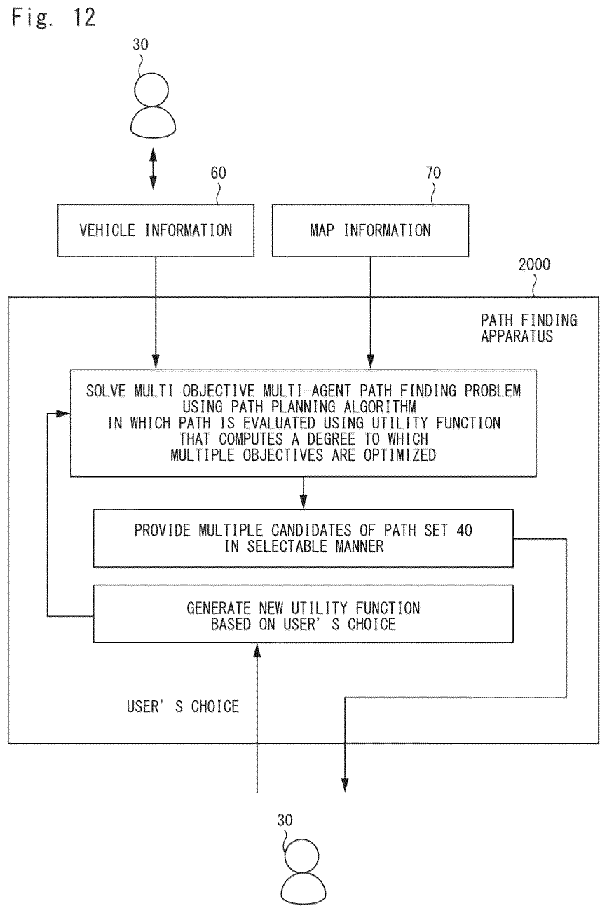

FIG. 12 illustrates an overview of the path finding apparatus 2000 of the second example embodiment. Note that the overview illustrated by FIG. 12 shows an example of operations of the path finding apparatus 2000 to make it easy to understand the path finding apparatus 2000, and does not limit or narrow the scope of possible operations of the path finding apparatus 2000.

The path finding apparatus 2000 of the second example embodiment is the same as that of the first example embodiment except that it elicits a preference of a user, e.g., regarding importance of each objective that is considered in the utility function (e.g., appropriate weights of objectives in the utility function that is defined as a weighted sum), and generates a new utility function whose configuration is determined based on the user preference.

A concrete way of configurating the utility function depends on a type of the utility function. For example, in the case where the utility function is defined as a weighted sum of multiple objectives, the configuration of the utility function is a set of weights of objectives. It is noted that the configuration of the utility function may be pre-defined in the first example embodiment.

Specifically, the path finding apparatus 2000 of the second example embodiment repeatedly solves the MOMAPF problem while updating the utility function until the appropriate utility function is found. In each iteration, the path finding apparatus 2000 provides a user with multiple candidates of the path set 40 that are generated by the MOMAPF solver using the utility functions with different configurations from each other, lets the user select one of the candidates, and generates a new utility function whose configuration is determined based on the configuration of the utility function with which the selected candidate is generated.

### Example of Advantageous Effect

Since the path finding apparatus 2000 uses the utility score of the path that is computed using the utility function to evaluate candidates of the path set 40, the preciseness of the evaluation depends on the configuration of the utility function. Specifically, the more appropriately the utility function is configured, the more precisely the utility score represents the utility of the path. However, it may be difficult for a user to figure out an appropriate configuration of the utility function by herself/himself.

According to the path finding apparatus 2000 of the second example embodiment, the utility function is repeatedly modified based on the user's choice of a path set from multiple candidates, thereby improving the utility function. Thus, the path finding apparatus 2000 can automatically generate the utility function that can precisely computes the utility of the path. As a result, the path finding apparatus 2000 can precisely provide the path set 40 with high utility.

Hereinafter, more detailed explanation of the path finding apparatus 2000 will be described.

### Example of Functional Configuration

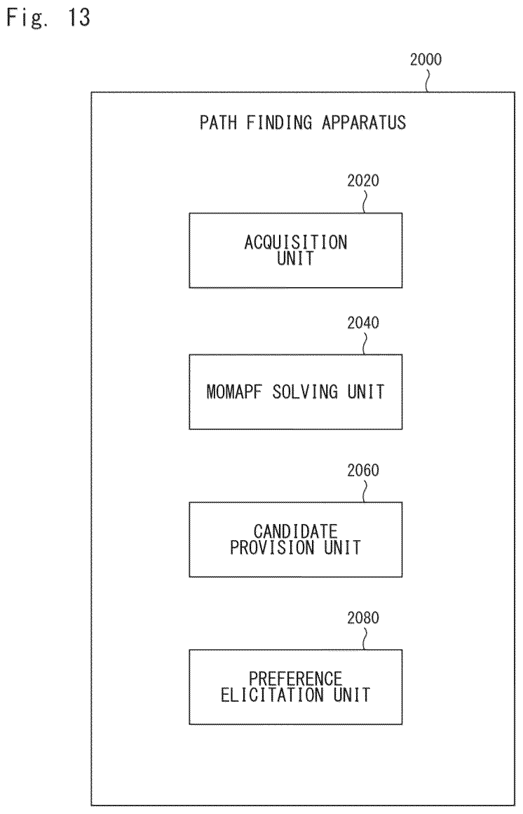

FIG. 13 is a block diagram that illustrates an example of functional configurations of the path finding apparatus 2000 of the second example embodiment. Comparing with the path finding apparatus 2000 of the first example embodiment, the path finding apparatus 2000 of the second example embodiment further includes a candidate provision unit 2060 and a preference elicitation unit 2080. The candidate provision unit 2060 provides the user with, in a selectable manner, two or more candidates of the path set 40 that are acquired as the solutions of the MOMAPF problem using different utility functions. The preference elicitation unit 2100 acquires information that indicates which candidate of path set 40 is selected by the user, and generates a new utility function based on the user's choice.

The MOMAPF solving unit 2040 then computes the MOMAPF solver with the new utility function. Then, the candidate provision unit 2060 provides the user with the candidate of the path set 40 that is generated using the new utility function and together with the candidate of the path set 40 that is most recently selected by the user. Until a predefined termination condition is satisfied, the path finding apparatus 2000 repeatedly generates a candidate of the path set 40 while providing multiple candidates of the path set 40 in a selectable manner and generating new utility function based on the user's choice of the candidate of the path set 40.

### Example of Hardware Configuration

The path finding apparatus 2000 of the second example embodiment may be realized by one or more computers similar to those realizing the path finding apparatus 2000 of the first example embodiment. Thus, its hardware configuration may also be depicted by FIG. 3.

### <Flow of Process>

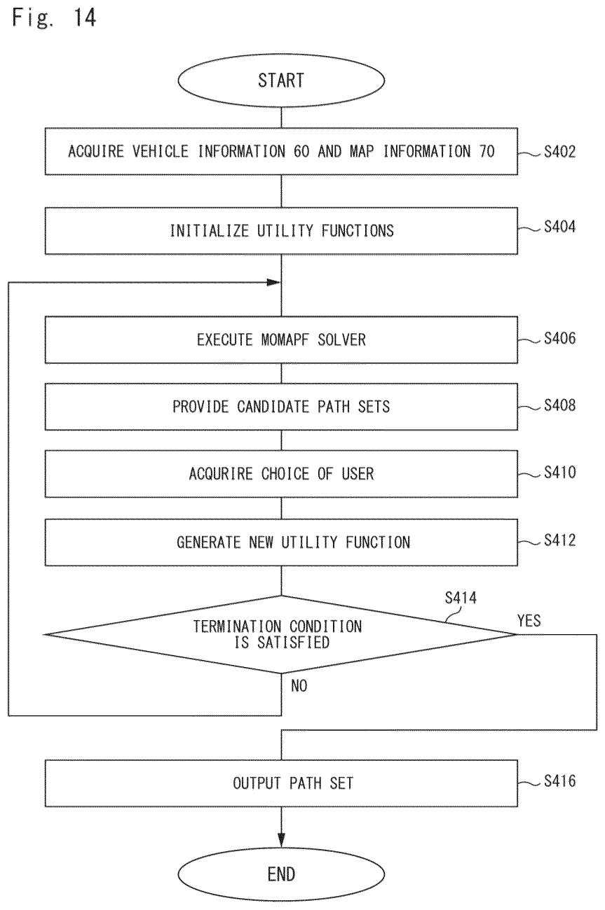

FIG. 14 is a flowchart illustrating an example of a process performed by the path finding apparatus 2000 of the second example embodiment. The acquisition unit 2020 of the second example embodiment acquires the vehicle information 60 and the map information 70 (S402), in the same manner as that of the first example embodiment. The MOMAPF solving unit 2040 initializes multiple utility functions whose configurations are different from each other (S404).

Steps S406 to S414 are repeatedly performed until a pre-defined termination condition is satisfied. The MOMAPF solving unit 2040 executes the MOMAPF solver (S406). In the first iteration, the MOMAPF solver is executed for each of the multiple utility functions that are initialized at Step S404. On the other hand, in the second iteration or later, the MOMAPF solver is executed for the utility functions that is generated at the previous Step S412.

The candidate provision unit 2060 provides two or more candidates of the path set 40 (S408), and acquires the choice of the user (S410). The preference elicitation unit 2080 generates a new utility function based on the acquired choice (S412).

The preference elicitation unit 2080 checks whether or not the termination condition is satisfied (S414). In the case where the termination condition is satisfied (S414: YES), the path finding apparatus 2000 outputs the path set 40 that is the latest choice of the user (S416).

On the other hand, in the case where the termination condition is not satisfied (S414: NO), the MOMAPF solving unit 2040 executes the MOMAPF solver with the new utility function (S406).

### <Initialization of Utility Function: S404>

The MOMAPF solving unit 2040 initializes multiple utility functions (S404). In this step, the MOMAPF solving unit 2040 generates multiple utility functions that have configurations different from each other. Suppose that the utility function is defined by the equation (7) described above, and two utility functions are generated in the initialization step. In this case, the MOMAPF solving unit 2040 may generate two utility functions: u_1(P) with the configuration “w_1=a, w_2=b, and w_3=c”; and u_2(P) with the configuration “w_1=d, w_2=e, and w_3=f” wherein the values a, b, c, d, e, and f are real numbers larger than or equal to 0, a+b+c=1, and d+e+f=1.

There are various ways to initialize the utility functions. In some implementations, the utility functions are generated in a random way: e.g., the weight of each objective is randomly determined.

### <Execution of MOMAPF Solver: S406>

The MOMAPF solving unit 2040 executes the MOMAPF solver to generate the candidate of the path set 40 (S406). In the first iteration (i.e., just after the initialization of the utility functions), the MOMAPF solving unit 2040 executes the MOMAPF solver for each of the multiple utility functions that are generated in the initialization step. When executing the MOMAPF solver with a certain utility function, this utility function is used to evaluate the candidate path in the MOMAPF solver.

In the second iteration or later, the MOMAPF solver is executed with the new utility function that is generated at the latest Step 412. Thus, the candidate path is evaluated using the new utility function.

It is noted that the user may not want to wait for multiple executions of the MOMAPF solver since solving multiple MOMAPF problems may be time-consuming. Thus, in some implementations, after acquiring the vehicle information 60 and the map information 70, the path finding apparatus may compute a solution of the MOMAPF problem for each of possible utility functions that may be proposed to the user without synchronizing with the elicitation of the user's preference. By doing so, the solution of the MOMAPF problem may be prepared for each of the possible utility functions in advance.

Thus, when the MOMAPF solver is executed with a new utility function, it may first determine whether or not the solution corresponding to the new utility function is already prepared. If the solution is prepared, the MOMAPF solver provides the prepared solution by retrieving it from a storage device in which the prepared solutions are stored, without solving the MOMAPF problem at the time. On the other hand, if the solution is not prepared yet, the MOMAPF solver solves the MAPF problem using the new utility function and provides the solution.

### <Provision of Candidate Path Set: S408>

The candidate provision unit 2060 provides multiple candidates of the path set 40 that are generated using different utility functions (S408). In the first iteration, the MOMAPF solving unit 2040 executes the MOMAPF solver using the utility functions with different configurations, thereby obtaining multiple candidates of the path set 40. The candidate provision unit 2060 may provide the user with these multiple candidates so that the user can compare those candidates with each other.

In the second iteration or later, the MOMAPF solving unit 2040 executes the MOMAPF solver using the new utility function generated at the latest Step 412, thereby obtaining a new candidate of the path set 40. Then, the multiple candidates of the path set 40 to be provided to the user are modified by replacing the candidate of the path set 40 that is not selected by the user in the previous iteration with the new candidate of the path set 40 that is generated in the current iteration. Thus, the candidate provision unit 2060 provides the user with the new candidate of the path set 40 generated in the current iteration together with the candidate of the path set 40 that is selected by the previous iteration, so that the user can compare the new candidate with the previously selected candidate.

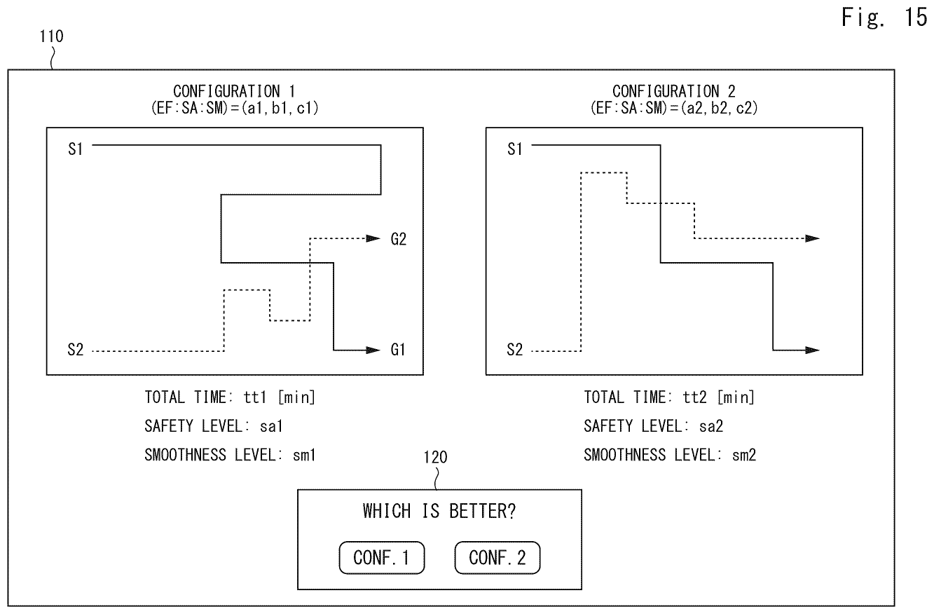

It is preferable that the candidate provision unit 2060 visually provides multiple candidates of the path set 40 so that the user can easily compare them with each other. FIG. 15 illustrates a visual provision of the multiple candidates of the path set 40. A window 110 is a window that may be displayed on a display device that the user can see, e.g., a display device of the user's mobile device, PC, and so on. In FIG. 15, it is assumed that the utility function is defined by the equation (7): a weighted sum of the efficiency, safety, and smoothness.

The window 110 visually shows two candidates of the path set 40. The candidate on the left side is generated using the utility function with the configuration “the weights of the efficiency (EF), safety (SA), and smoothness (SM) are a1, b1, and c1 respectively”. The candidate on the right side is generated using the utility function with the configuration “the weights of the efficiency (EF), safety (SA), and smoothness (SM) are a2, b2, and c2 respectively”. The window 110 also shows the total time of travel (the efficiency of the path set 40), the safety level, and the smoothness level so that the user can select one of the candidates of the path set 40 while taking those values into consideration.

An input interface 120 includes two buttons: the left one is used to select the configuration 1 whereas the right one is used to select the configuration 2. The user can select one of the candidates of the path set 40 by pushing the corresponding button.

### <Acquisition of User's Choice: S410>

The preference elicitation unit 2080 acquires the user's choice (S410). There various ways to acquire which option is chosen by the user. For example, in the case exemplified by FIG. 15, the preference elicitation unit 2080 acquire information that indicates which button is pushed by the user.

### <Generation of Utility Function: S412>

The preference elicitation unit 2080 generates a new utility function based on the user's choice of the candidate of the path set 40. Specifically, the preference elicitation unit 2080 determines a new configuration of the utility function based on the user's choice of the candidate of the path set 40, and generates a utility function with the determined configuration.

There are various ways to determine a configuration of the utility function based on the user's choice of the candidate of the path set 40. In some implementations, the preference elicitation unit 2080 uses a Bayesian optimization to determine the configuration of the utility function. For example, a Bayesian optimization with Gaussian process, which is disclosed by NPL3 or 4, may be used. More precisely, a Gaussian Probit model (NPL3 and NPL4) may be used for preference learning. In this case, in each iteration, the preference elicitation unit 2080 obtains the configuration of the utility function that is used to generate the candidate of the path set 40 chosen by the user in Step S410 of the current iteration, and performs a Bayesian optimization with Gaussian process using the obtained configuration of the utility function as an input. Then, the preference elicitation unit 2080 obtains a new configuration of the utility function as an output of the Bayesian optimization, and generates a new utility function with the obtained new configuration. In the Bayesian optimization with Gaussian process, Matern kernel is commonly used. However, any type of kernel may be used by the preference elicitation unit 2080. Also, an acquisition function that may be commonly used is the Upper Confidence Bound.

### <Termination of Preference Elicitation: S414>

The path finding apparatus 2000 outputs the path set 40 when the termination condition is satisfied. There are various conditions that can be included in the termination condition. For example, the termination condition may include a condition “the number of iterations reaches a pre-defined threshold”. In this case, the path finding apparatus 2000 outputs the path set 40 when Step S414 is performed more than pre-determined times.

Alternatively, or in addition, the termination condition may include a condition “the generation model reaches convergence”. It is noted that there are various well-known techniques to determine whether or not a generation model reaches convergence, and one of those techniques can be used to determine whether or not the generation model reaches convergence.

### <Output of Result>

After the termination condition is satisfied (S414: YES), the path finding apparatus 2000 outputs the output information that indicates, as the path set 40, the candidate of the path set 40 that is the latest choice of the user. A way of outputting the output information is already explained in the first example embodiment.

Although the present disclosure is explained above with reference to example embodiments, the present disclosure is not limited to the above-described example embodiments. Various modifications that can be understood by those skilled in the art can be made to the configuration and details of the present disclosure within the scope of the invention.

The programs mentioned in this disclosure include instructions (or software codes) that, when loaded into a computer, cause the computer to perform one or more of the functions described in the embodiments. The program may be stored in a non-transitory computer readable medium or a tangible storage medium. By way of example, and not a limitation, non-transitory computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray disc or other types of optical disc storage, and magnetic cassettes, magnetic tape, magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

The whole or part of the example embodiments disclosed above can be described as, but not limited to, the following supplementary notes.

### <Supplementary Notes>

### (Supplementary Note 1)

A path finding apparatus comprising:

at least one processor; and

memory storing instructions;

wherein the at least one processor is configured to execute the instructions to:

acquire vehicle information and map information, the vehicle information indicating a pair of a start location and a goal location for each of a plurality of vehicles, the map information indicating a map of space in which the vehicles travel; and

determine a path set that includes a path for each of the vehicles using the vehicle information and the map information, the paths in the path set not conflicting with each other,

wherein the determination of the path set includes performing a path planning algorithm to generate the path for each of the vehicles, the path planning algorithm evaluating the path based on a utility score of the path that is a scalar value representing a degree to which a plurality of objectives are optimized by the path.

### (Supplementary Note 2)

The path finding apparatus according to supplementary note 1, wherein the determination of the path set includes executing a modified version of a Conflict Based Search algorithm whose low-level search is performed by executing the path planning algorithm that is implemented by a metaheuristic algorithm.

### (Supplementary Note 3)

The path finding apparatus according to supplementary note 1 or 2,

wherein the path planning algorithm uses a utility function to compute the utility score of the target path, and

the utility function is defined as a weighted sum of a plurality of objective terms each of which represents a degree to which the objective corresponding to that objective term is optimized by the path.

### (Supplementary Note 4)

The path finding apparatus according to supplementary note 3, wherein the plurality of objectives including efficiency of the path, safety of the path, smoothness of the path, or two or more thereof.

### (Supplementary Note 5)

The path finding apparatus according to any one of supplementary notes 1 to 4,

wherein the path planning algorithm uses a utility function to compute the utility score of the target path, and

the determination of the path set includes, until a termination condition is satisfied, repeatedly performing:

providing a user with a plurality of candidates of the path set in a selectable manner;

acquiring information that indicates the candidate of the path set selected by the user;

generating a new utility function based on the selected candidate of the path set;

determining a new candidate of the path set using the new utility function; and

replacing one of the plurality of candidates of the path sets to be provided to the user with the new candidate of the path set.

### (Supplementary Note 6)

The path finding apparatus according to supplementary notes 5,

wherein the generation of the new utility function further includes:

performing a Bayesian optimization with Gaussian process using, as an input, a configuration of the utility function that is used to generate the candidate of the path set that is most recently selected by the user, thereby obtaining a new configuration of the utility function; and

generating the new utility function with the obtained new configuration.

### (Supplementary Note 7)

A control method executed by a computer, comprising:

acquiring vehicle information and map information, the vehicle information indicating a pair of a start location and a goal location for each of a plurality of vehicles, the map information indicating a map of space in which the vehicles travel; and

determining a path set that includes a path for each of the vehicles using the vehicle information and the map information, the paths in the path set not conflicting with each other,

wherein the determination of the path set includes performing a path planning algorithm to generate the path for each of the vehicles, the path planning algorithm evaluating the path based on a utility score of the path that is a scalar value representing a degree to which a plurality of objectives are optimized by the path.

### (Supplementary Note 8)

The control method according to supplementary note 7,

wherein the determination of the path set includes executing a modified version of a Conflict Based Search algorithm whose low-level search is performed by executing the path planning algorithm that is implemented by a metaheuristic algorithm.

### (Supplementary Note 9)

The control method according to supplementary note 7 or 8, wherein the path planning algorithm uses a utility function to compute the utility score of the target path, and

the utility function is defined as a weighted sum of a plurality of objective terms each of which represents a degree to which the objective corresponding to that objective term is optimized by the path.

### (Supplementary Note 10)

The control method according to supplementary note 9,

wherein the plurality of objectives including efficiency of the path, safety of the path, smoothness of the path, or two or more thereof.

### (Supplementary Note 11)

The control method according to any one of supplementary notes 7 to 10,

wherein the path planning algorithm uses a utility function to compute the utility score of the target path, and

the determination of the path set includes, until a termination condition is satisfied, repeatedly performing:

providing a user with a plurality of candidates of the path set in a selectable manner;

acquiring information that indicates the candidate of the path set selected by the user;

generating a new utility function based on the selected candidate of the path set;

determining a new candidate of the path set using the new utility function; and

replacing one of the plurality of candidates of the path sets to be provided to the user with the new candidate of the path set.

### (Supplementary Note 12)

The control method according to supplementary notes 11,

wherein the generation of the new utility function further includes:

performing a Bayesian optimization with Gaussian process using, as an input, a configuration of the utility function that is used to generate the candidate of the path set that is most recently selected by the user, thereby obtaining a new configuration of the utility function; and

generating the new utility function with the obtained new configuration.

### (Supplementary Note 13)

A non-transitory computer-readable storage medium storing a program that causes a computer to execute:

acquiring vehicle information and map information, the vehicle information indicating a pair of a start location and a goal location for each of a plurality of vehicles, the map information indicating a map of space in which the vehicles travel; and

determining a path set that includes a path for each of the vehicles using the vehicle information and the map information, the paths in the path set not conflicting with each other,

wherein the determination of the path set includes performing a path planning algorithm to generate the path for each of the vehicles, the path planning algorithm evaluating the path based on a utility score of the path that is a scalar value representing a degree to which a plurality of objectives are achieved by the path.

### (Supplementary Note 14)

The storage medium according to supplementary note 13,

wherein the determination of the path set includes executing a modified version of a Conflict Based Search algorithm whose low-level search is performed by executing the path planning algorithm that is implemented by a metaheuristic algorithm.

### (Supplementary Note 15)

The storage medium according to supplementary note 13 or 14,

wherein the path planning algorithm uses a utility function to compute the utility score of the target path, and

the utility function is defined as a weighted sum of a plurality of objective terms each of which represents a degree to which the objective corresponding to that objective term is optimized by the path.

### (Supplementary Note 16)

The storage medium according to supplementary note 15,

wherein the plurality of objectives including efficiency of the path, safety of the path, smoothness of the path, or two or more thereof.

### (Supplementary Note 17)

The storage medium according to any one of supplementary notes 13 to 16,

wherein the path planning algorithm uses a utility function to compute the utility score of the target path, and

the determination of the path set includes, until a termination condition is satisfied, repeatedly performing:

providing a user with a plurality of candidates of the path set in a selectable manner;

acquiring information that indicates the candidate of the path set selected by the user;

generating a new utility function based on the selected candidate of the path set;

determining a new candidate of the path set using the new utility function; and

replacing one of the plurality of candidates of the path sets to be provided to the user with the new candidate of the path set.

### (Supplementary Note 18)

The storage medium according to supplementary notes 17,

wherein the generation of the new utility function further includes:

performing a Bayesian optimization with Gaussian process using, as an input, a configuration of the utility function that is used to generate the candidate of the path set that is most recently selected by the user, thereby obtaining a new configuration of the utility function; and

generating the new utility function with the obtained new configuration.

This application is based upon and claims the benefit of priority from Japanese patent application No. 2021-198987, filed on Dec. 8, 2021, the disclosure of which is incorporated herein in its entirety by reference.

### REFERENCE SIGNS LIST

10 vehicle set
20 vehicle
30 entity
40 path set
50 path
60 vehicle information
70 map information
80 candidate path
90 location
100 waypoints
110 window
120 input interface
1000 computer
1020 bus
1040 processor
1060 memory
1080 storage device
1100 input/output interface
1120 network interface
2000 path finding apparatus
2020 acquisition unit
2040 MOMAPF solving unit
2060 candidate provision unit
2080 preference elicitation unit

What is claimed is:

1. A path finding apparatus comprising:
at least one processor; and
memory storing instructions;
wherein the at least one processor is configured to execute the instructions to:
acquire vehicle information and map information, the vehicle information indicating a pair of a start location and a goal location for each of a plurality of vehicles, the map information indicating a map of space in which the vehicles travel; and
determine a path set that includes a path for each of the vehicles using the vehicle information and the map information, the paths in the path set not conflicting with each other,
wherein the determination of the path set includes performing a path planning algorithm to generate the path for each of the vehicles, the path planning algorithm evaluating the path based on a utility score of the path that is a scalar value representing a degree to which a plurality of objectives are optimized by the path.

2. The path finding apparatus according to claim 1,
wherein the determination of the path set includes executing a modified version of a Conflict Based Search algorithm whose low-level search is performed by executing the path planning algorithm that is implemented by a metaheuristic algorithm.

3. The path finding apparatus according to claim 1,
wherein the path planning algorithm uses a utility function to compute the utility score of the target path, and
the utility function is defined as a weighted sum of a plurality of objective terms each of which represents a degree to which the objective corresponding to that objective term is optimized by the path.

4. The path finding apparatus according to claim 3,
wherein the plurality of objectives including efficiency of the path, safety of the path, smoothness of the path, or two or more thereof.

5. The path finding apparatus according to claim 1,
wherein the path planning algorithm uses a utility function to compute the utility score of the target path, and
the determination of the path set includes, until a termination condition is satisfied, repeatedly performing:
providing a user with a plurality of candidates of the path set in a selectable manner;
acquiring information that indicates the candidate of the path set selected by the user;
generating a new utility function based on the selected candidate of the path set;
determining a new candidate of the path set using the new utility function; and
replacing one of the plurality of candidates of the path sets to be provided to the user with the new candidate of the path set.

6. The path finding apparatus according to claim 5,
wherein the generation of the new utility function further includes:
performing a Bayesian optimization with Gaussian process using, as an input, a configuration of the utility function that is used to generate the candidate of the path set that is most recently selected by the user, thereby obtaining a new configuration of the utility function; and
generating the new utility function with the obtained new configuration.

7. A control method executed by a computer, comprising:
acquiring vehicle information and map information, the vehicle information indicating a pair of a start location and a goal location for each of a plurality of vehicles, the map information indicating a map of space in which the vehicles travel; and
determining a path set that includes a path for each of the vehicles using the vehicle information and the map information, the paths in the path set not conflicting with each other,
wherein the determination of the path set includes performing a path planning algorithm to generate the path for each of the vehicles, the path planning algorithm evaluating the path based on a utility score of the path that is a scalar value representing a degree to which a plurality of objectives are optimized by the path.

8. The control method according to claim 7,
wherein the determination of the path set includes executing a modified version of a Conflict Based Search algorithm whose low-level search is performed by executing the path planning algorithm that is implemented by a metaheuristic algorithm.

9. The control method according to claim 7,
wherein the path planning algorithm uses a utility function to compute the utility score of the target path, and
the utility function is defined as a weighted sum of a plurality of objective terms each of which represents a degree to which the objective corresponding to that objective term is optimized by the path.

10. The control method according to claim 9,
wherein the plurality of objectives including efficiency of the path, safety of the path, smoothness of the path, or two or more thereof.

11. The control method according to claim 7,
wherein the path planning algorithm uses a utility function to compute the utility score of the target path, and
the determination of the path set includes, until a termination condition is satisfied, repeatedly performing:
providing a user with a plurality of candidates of the path set in a selectable manner;
acquiring information that indicates the candidate of the path set selected by the user;
generating a new utility function based on the selected candidate of the path set;
determining a new candidate of the path set using the new utility function; and
replacing one of the plurality of candidates of the path sets to be provided to the user with the new candidate of the path set.

12. The control method according to claim 11,
wherein the generation of the new utility function further includes:
performing a Bayesian optimization with Gaussian process using, as an input, a configuration of the utility function that is used to generate the candidate of the path set that is most recently selected by the user, thereby obtaining a new configuration of the utility function; and
generating the new utility function with the obtained new configuration.

13. A non-transitory computer-readable storage medium storing a program that causes a computer to execute:
acquiring vehicle information and map information, the vehicle information indicating a pair of a start location and a goal location for each of a plurality of vehicles, the map information indicating a map of space in which the vehicles travel; and
determining a path set that includes a path for each of the vehicles using the vehicle information and the map information, the paths in the path set not conflicting with each other,
wherein the determination of the path set includes performing a path planning algorithm to generate the path for each of the vehicles, the path planning algorithm evaluating the path based on a utility score of the path that is a scalar value representing a degree to which a plurality of objectives are achieved by the path.

14. The non-transitory computer-readable storage medium according to claim 13,
wherein the determination of the path set includes executing a modified version of a Conflict Based Search algorithm whose low-level search is performed by executing the path planning algorithm that is implemented by a metaheuristic algorithm.

15. The non-transitory computer-readable storage medium according to claim 13,
wherein the path planning algorithm uses a utility function to compute the utility score of the target path, and
the utility function is defined as a weighted sum of a plurality of objective terms each of which represents a degree to which the objective corresponding to that objective term is optimized by the path.

16. The non-transitory computer-readable storage medium according to claim 15,
wherein the plurality of objectives including efficiency of the path, safety of the path, smoothness of the path, or two or more thereof.

17. The non-transitory computer-readable storage medium according to claim 13,
wherein the path planning algorithm uses a utility function to compute the utility score of the target path, and
the determination of the path set includes, until a termination condition is satisfied, repeatedly performing:
providing a user with a plurality of candidates of the path set in a selectable manner;
acquiring information that indicates the candidate of the path set selected by the user;
generating a new utility function based on the selected candidate of the path set;
determining a new candidate of the path set using the new utility function; and
replacing one of the plurality of candidates of the path sets to be provided to the user with the new candidate of the path set.

18. The non-transitory computer-readable storage medium according to claim 17,
wherein the generation of the new utility function further includes:
performing a Bayesian optimization with Gaussian process using, as an input, a configuration of the utility function that is used to generate the candidate of the path set that is most recently selected by the user, thereby obtaining a new configuration of the utility function; and
generating the new utility function with the obtained new configuration.
